(19) United States
(12) Patent Application Publication
(10) Pub. No.: US 2024/0424842 A1
(43) Pub. Date: Dec. 26, 2024

(54) QUICK DISCONNECT SYSTEM FOR A HITCH RECEIVER

(71) Applicant: Suweeka Ltd., Portland, OR (US)

(72) Inventor: Spencer T. HOUSER, Portland, OR (US)

(73) Assignee: Suweeka Ltd., Portland, OR (US)

(21) Appl. No.: 18/337,525

(22) Filed: Jun. 20, 2023

(51) Int. Cl. B60D 1/36; B60D 1/07

(52) U.S. Cl. CPC B60D 1/363; B60D 1/075

(57) ABSTRACT

A quick connect system for a hitch receiver of a vehicle includes a hanger plate and an adapter plate. The hanger plate includes a hanger base portion configured to attach to the hitch receiver. First and second hanger side flanges extend rearwardly from opposing sides of the hanger base portion. The top surfaces of the hanger side flanges are each contoured to form a recessed seat section. The adapter plate includes an adapter base portion. First and second adapter side flanges extend rearwardly from opposing sides of the adapter base portion. A hanger bar extends between the adapter side flanges. A latching mechanism is attached to the adapter base portion. The hanger bar is configured to fit into the recessed seat sections to enable the adapter plate to pivot against the hanger plate and to removably latch the latching mechanism to the hanger plate.

### TECHNICAL FIELD

The present disclosure relates to connection systems for engagement to a hitch receiver of a vehicle and methods of making the same. More specifically, the disclosure relates to quick disconnect systems for engagement to a hitch receiver and methods of making the same.

### BACKGROUND

Hitch receivers are widely accepted in the industry and marketplace. Such hitch receivers may include a longitudinally extending receiver tube having a square cross section (for example 2 inch by 2 inch). Often a hitch receiver mounted accessory, such as a bike rack, includes a shank that is sized to slip fit into the receive tube in order to securely connect the accessory to the hitch receiver.

Problematically however, when connecting such hitch receiver mounted accessories to a hitch receiver, a user may be required to support the entire weight of the accessory in an awkward position, in order to properly align the shank of the accessory with the receiver tube. Also problematically, the hitch receiver mounted accessory may not be easily disconnected once it is installed, and may interfere with the movement of a tail gate of a vehicle. Further the connection systems of a hitch receiver mounted accessory often require tooling to connect and disconnect, which can involve a labor intensive process.

Moreover, hitch receiver mounted accessories, such as racks, may require the item to be supported by the accessory, such as a bike, to be lifted off the ground a foot or more in order to secure the bike to the rack. However, many items that are desirable to be supported by such a hitch receiver mounted accessory can be heavy for a user to lift.

For example, electric bicycles (E-bikes), which are rapidly becoming mainstream in the marketplace, may weigh between 50 to 100 pounds. The weight of such E-bikes may exceed the capacity of many currently available bike racks. Most racks won't support more than 40 pounds per bike, and all must have the bicycles lifted up onto the rack, a challenging prospect at best.

Accordingly, there is a need for a connection system for engagement with a hitch receiver that can easily connect and disconnect to the hitch receiver without tooling. Also there is a need to be able to connect and disconnect a hitch receiver mounted accessory, such as a rack, without requiring the user to align a shank of the accessory with the receiver tube while supporting the entire weight of the accessory. Additionally, there is a need to be able to mount a heavy item onto an accessory, without the need for a user to manually lift the item.

### BRIEF DESCRIPTION OF THE INVENTION

The present disclosure offers advantages and alternatives over the prior art by providing a quick connect system for a hitch receiver. The quick connect system includes a hanger plate, which is connectable to the hitch receiver, and an adapter plate, which can easily connect and disconnect to the hanger plate without the use of tooling.

Additionally, the present disclosure advantageously provides a hitch receiver mounted accessory system, such as a rack system, that may include the quick connect system. The system has a loading position, wherein an item to be mounted on the hitch receiver mounted accessory system does not require manual lifting. The system also has a fully lifted position, to which the hitch receiver mounted accessory system may lift the item to.

A quick connect system for a hitch receiver of a vehicle in accordance with one or more aspects of the present disclosure includes a hanger plate and an adapter plate. The hanger plate includes a hanger base portion configured to attach to the hitch receiver. First and second hanger side flanges extend rearwardly from opposing sides of the hanger base portion. Top surfaces of the hanger side flanges are each contoured to form a recessed seat section. The adapter plate includes an adapter base portion. First and second adapter side flanges extend rearwardly from opposing sides of the adapter base portion. A hanger bar extends between the adapter side flanges. A latching mechanism is attached to the adapter plate. The hanger bar is configured to fit into the recessed seat sections to enable the adapter plate to pivot against the hanger plate and to removably latch the latching mechanism to the hanger plate.

A hitch receiver mounted accessory system for a hitch receiver of a vehicle in accordance with one or more aspects of the present disclosure includes a quick connect system, a frame assembly and a jack assembly. The quick connect system includes a hanger plate and an adapter plate. The hanger plate is configured to attach to the hitch receiver. The adapter plate is configured to removably attach to the hanger plate. The frame assembly includes a first post rigidly connected to the adapter plate at a lower end portion and extends upwards to an upper end portion. A bottom lifter plate is pivotally connected to the adapter plate at a first end portion and extends outwards to a second end portion. A top lifter plate is pivotally connected to the upper end portion of the first post at a first end portion and extends outwards to a second end portion. A second post is pivotally connected between the second end portions of the top and bottom lifter plates. The jack assembly has an extendable member. The jack assembly is pivotally connected to the adapter plate at a distal end portion of the extendable member and pivotally connected to a midportion of the top lifter plate at a midportion of the jack assembly. When the jack assembly extends the extendable member from a retracted position to an extended position, the frame assembly pivots around the first post from a loading position to a fully lifted position.

A method of lifting cargo with a hitch receiver mounted accessory system for a hitch receiver of a vehicle in accordance with one or more aspects of the present disclosure includes attaching a hanger plate of the hitch receiver mounted accessory system to the hitch receiver. A hanger bar of an adapter plate of the hitch receiver mounted accessory system is positioned into recessed seat sections formed into first and second side flanges of the hanger plate. The adapter plate is pivoted against the hanger plate to removably latch the adapter plate to the hanger plate.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits and advantages described herein.

### BRIEF DESCRIPTION OF THE DRAWINGS

The disclosure will be more fully understood from the following detailed description taken in conjunction with the accompanying drawings, in which:

FIG. 1 depicts an example of a perspective view of a quick connect system mounted on a hitch receiver of a vehicle, according to aspects described herein;

FIG. 2A depicts an example of a perspective view of a hanger plate of a quick connect system for a hitch receiver, according to aspects described herein;

FIG. 2B depicts an example of a front view of the hanger plate of FIG. 2A, according to aspects described herein;

FIG. 2C depicts an example of a side view of the hanger plate of FIG. 2A, according to aspects described herein;

FIG. 3A depicts an example of a perspective view of an adapter plate of a quick connect system for a hitch receiver, according to aspects described herein;

FIG. 3B depicts an example of a front view of the adapter plate of FIG. 3A, according to aspects described herein;

FIG. 3C depicts an example of a side view of the adapter plate of FIG. 3A, according to aspects described herein;

FIG. 4 depicts an example of a front view of a quick disconnect system, wherein the hanger plate and adapter plate are fully engaged, according to aspects described herein;

FIG. 5 depicts an example of a cross sectional view of the quick disconnect system of FIG. 4 taken along the line A-A in FIG. 4, wherein the hanger plate and adapter plate are fully engaged, according to aspects described herein;

FIG. 6 depicts an example of a cross sectional view of the quick disconnect system of FIG. 4 taken along the line A-A in FIG. 4, wherein the hanger plate and adapter plate are partially disengaged, according to aspects described herein;

FIG. 7 depicts an example of a cross sectional view of the quick disconnect system of FIG. 4 taken along the line A-A in FIG. 4, wherein the hanger plate and adapter plate are fully disengaged, according to aspects described herein;

FIG. 8A depicts an alternative example of a perspective view of a hanger plate of a quick connect system for a hitch receiver, according to aspects described herein;

FIG. 8B depicts an example of a front view of the hanger plate of FIG. 8A, according to aspects described herein;

FIG. 8C depicts an example of a side view of the hanger plate of FIG. 8A, according to aspects described herein;

FIG. 9A depicts an alternative example of a perspective view of an adapter plate of a quick connect system for a hitch receiver, according to aspects described herein;

FIG. 9B depicts an example of a front view of the adapter plate of FIG. 9A, according to aspects described herein;

FIG. 9C depicts an example of a side view of the adapter plate of FIG. 9A, according to aspects described herein;

FIG. 10 depicts a perspective view of a hitch receiver mounted accessory system in a loading position, according to aspects described herein;

FIG. 11 depicts a perspective view of the hitch receiver mounted accessory system of FIG. 10 in a partially lifted position, according to aspects described herein;

FIG. 12 depicts a perspective view of the hitch trailer mounted accessory system of FIG. 10 in a fully lifted position, according to aspects described herein;

FIG. 13 depicts a perspective view of the hitch receiver mounted accessory system of FIG. 10, in a fully lifted position and with a pair of lifter forks in a vertically extending storage position, according to aspects described herein; and

FIG. 14 depicts an example of a flow diagram of a method of lifting cargo with a hitch mounted accessory system for a trailer hitch receiver of a vehicle, according to aspects described herein.

### DETAILED DESCRIPTION

Certain examples will now be described to provide an overall understanding of the principles of the structure, function, manufacture, and use of the methods, systems, and devices disclosed herein. One or more examples are illustrated in the accompanying drawings. Those skilled in the art will understand that the methods, systems, and devices specifically described herein and illustrated in the accompanying drawings are non-limiting examples and that the scope of the present disclosure is defined solely by the claims. The features illustrated or described in connection with one example may be combined with the features of other examples. Such modifications and variations are intended to be included within the scope of the present disclosure.

The terms “significantly”, “substantially”, “approximately”, “about”, “relatively,” or other such similar terms that may be used throughout this disclosure, including the claims, are used to describe and account for small fluctuations, such as due to variations in processing from a reference or parameter. Such small fluctuations include a zero fluctuation from the reference or parameter as well. For example, they can refer to less than or equal to +10%, such as less than or equal to +5%, such as less than or equal to +2%, such as less than or equal to +1%, such as less than or equal to +0.5%, such as less than or equal to +0.2%, such as less than or equal to +0.1%, such as less than or equal to +0.05%.

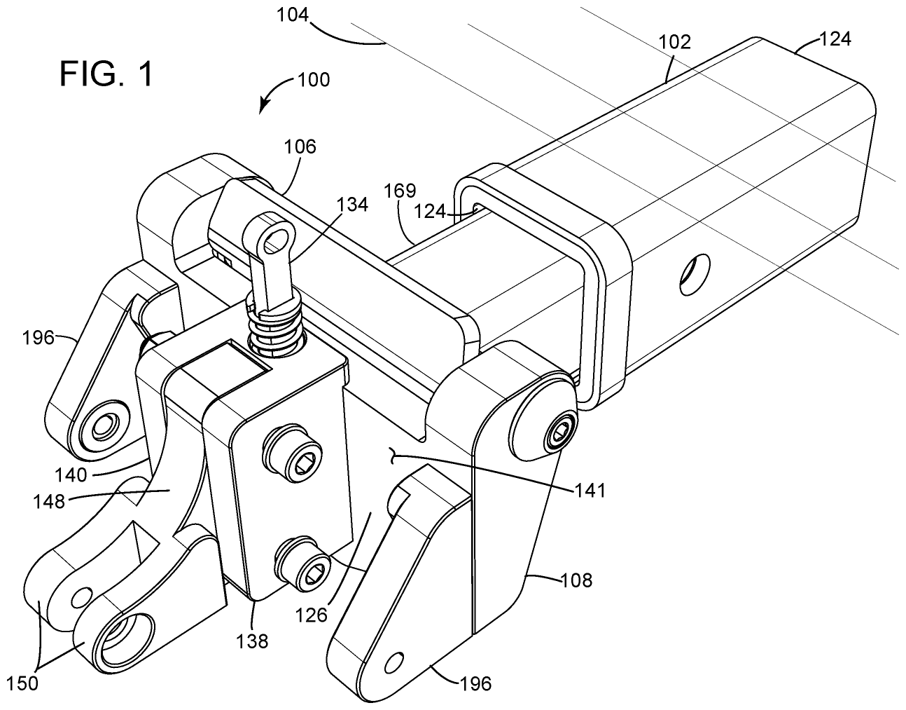

Referring to FIG. 1, an example is depicted of a perspective view of a quick connect system 100 mounted on a hitch receiver 102 of a vehicle 104, according to aspects described herein. The quick connect system 100 includes a hanger plate 106 and an adapter plate 108. The hanger plate 106 may be configured to attach directly to the hitch receiver 102. Alternatively, the hanger plate 106 may be mounted to a shank 169 as shown in FIG. 1, which extends through the thru-hole 124 of the hitch receiver 102. The hanger plate 106 may be attached to the hitch receiver 102 or shank 169 by any appropriate connection process, such as, for example, by welding or bolting.

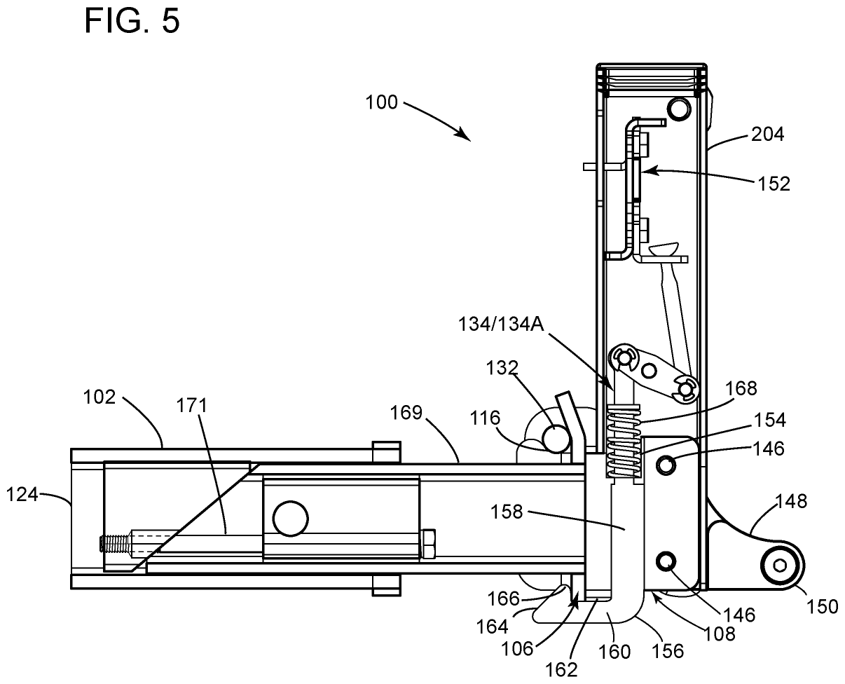

As will be explained in greater detail herein, the adapter plate 108 is configured to quickly and securely connect to, and disconnect from, the hanger plate by hand, without the use of any tools. The adapter plate 108 includes a latching mechanism 134 that removably latches the adapter plate 108 to the hanger plate 106. A user may later operate a release mechanism (such as the release mechanism 152 shown in FIG. 5) to unlatch the adapter plate 108 from the hanger plate 106.

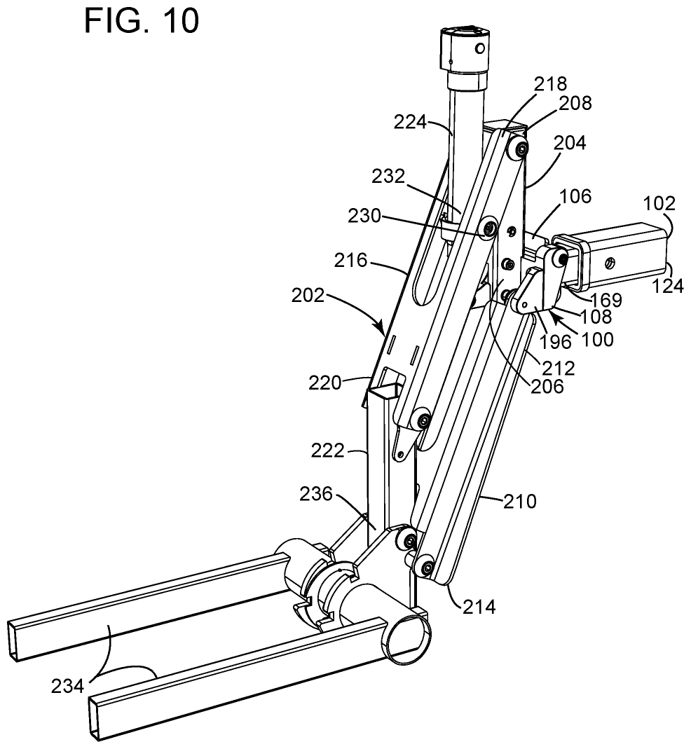

Additionally, the front surface 141 of the adapter plate 108 may have a number of flanges and/or plates attached to it in order to connect to various connections or devices of, for example, a hitch receiver mounted accessory system 200 such as shown in FIGS. 10-13. For example, the adapter plate 108 may also include a first midsection flange 138 and a second midsection flange 140. The first and second midsection flanges 136, 138 may extend forwardly from the front surface 141 of the adapter base portion 126 of the adapter plate 108. The midsection flanges 136, 138 are parallel to each other and straddle the latching mechanism 134. Moreover, a two-pronged jack adapter 148 may be bolted between the first and second midsection flanges 138, 140. As will be explained in greater detail herein, the two prongs 150 of the two-pronged jack adapter 148 may be used to straddle, and bolt to, a distal end portion 228 of an extendable member 226 of a jack assembly 224 of a hitch receiver mounted accessory system 200 (such as a rack system 200), thereby pivotally connecting the extendable member 226 to the adapter plate 108 (see FIG. 10).

Also, by way of example, a pair of lifter plate adapters 196 may be bolted to opposing sides of the front surface 141 of the adapter plate 108. As will be explained in greater detail herein, the pair of lifter plate adapters 196 may be used to pivotally connect to a first end portion 212 of a bottom lifter plate 210 of the hitch receiver mounted accessory system 200 (see FIGS. 10-13).

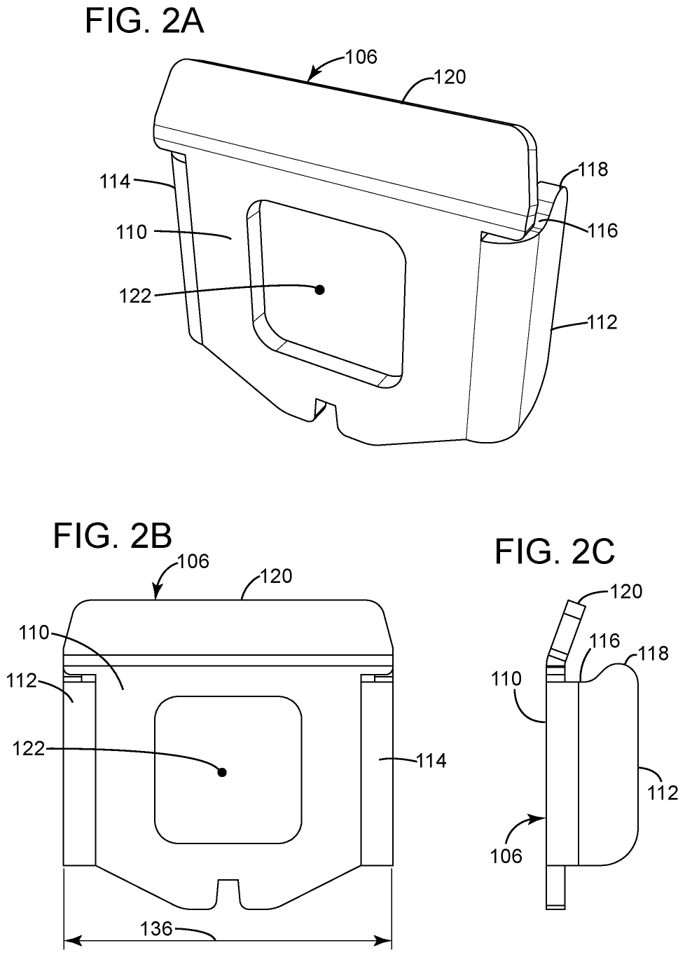

Referring to FIGS. 2A, 2B and 2C, an example is depicted of perspective view (FIG. 2A), a front view (FIG. 2B) and a side view (FIG. 2C) of the hanger plate 106 of the quick connect system 100 for a hitch receiver 102, according to aspects described herein.

The hanger plate 106 includes a hanger base portion 110. The hanger base portion 110 is configured to attach to the hitch receiver 102 of the vehicle 104. The base portion 110 may be attached to the hitch receiver 102 by welding, bolting or any other fastening system that is appropriate for the performance parameters required.

The hanger base portion 110 also includes a first hanger side flange 112 and a second hanger side flange 114. The first and second hanger side flanges 112, 114 extend rearwardly from opposing sides of the hanger base portion 110 in the direction of the vehicle 104. The top surfaces of the hanger side flanges 112, 114 are each contoured to form a recessed seat section 116. The first and second hanger side flanges 112, 114 each including a raised upper corner portion 118, which forms a portion of the recessed seat sections 116.

The hanger plate 106 also includes a hanger top flange 120, which extends rearwardly in the direction of the vehicle 106 at an acute angle from a top of the hanger base portion 110. The hanger top flange 120 extends at least partially over the recessed seat sections 116 of the first and second hanger side flanges 112, 114.

The hanger base portion 110 of the hanger plate 106 also has a base thru-hole 122 extending therethrough. That is, the base thru-hole 122 extends entirely through the hanger base portion 110. The base thru-hole 122 is configured to fit over a thru-hole 124 (see FIGS. 1 and 5) of the hitch receiver 102, when the hanger plate 106 is attached to the hitch receiver 102.

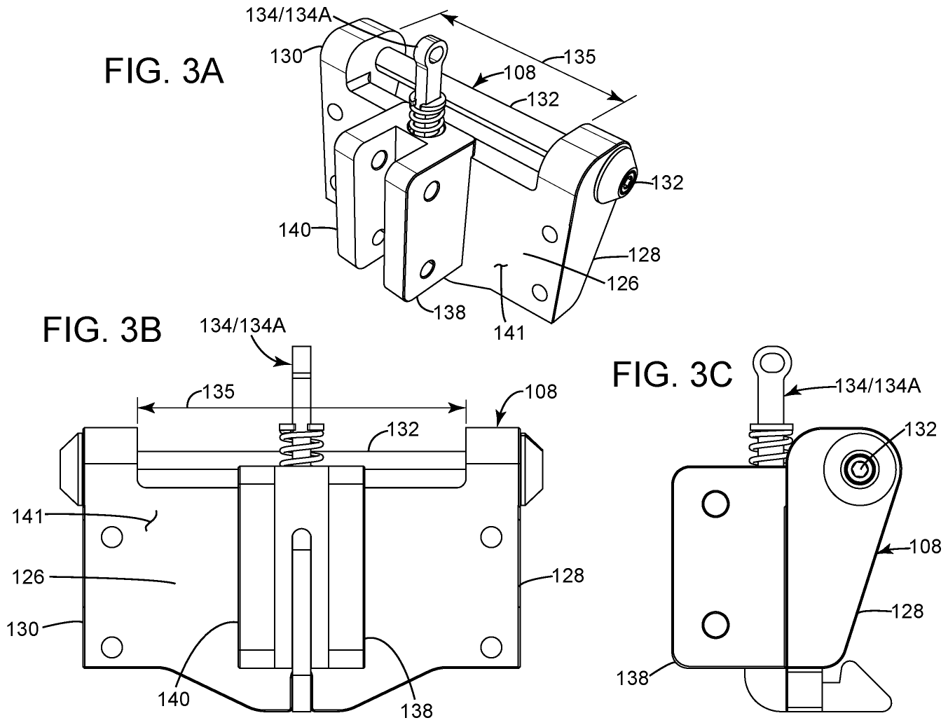

Referring to FIGS. 3A, 3B and 3C an example is depicted of a perspective view (FIG. 3A), a front view (FIG. 3B) and a side view (FIG. 3C) of the adapter plate 108 of the quick connect system 100 for a hitch receiver 102, according to aspects described herein. The adapter plate 108 includes an adapter base portion 126. first and second adapter side flanges 128, 130, a hanger bar 132 and a latching mechanism 134.

The first adapter side flange 128 and the second adapter side flange 130 extend rearwardly in the direction of the vehicle from opposing sides of the adapter base portion 126. The first and second adapter side flanges 128, 130 are spaced apart a distance 135 greater than an overall width 136 (see FIG. 2B) of the hanger plate 106. Accordingly, the first and second adapter side flanges 128, 130 fit over the first and second hanger side flanges 112, 114 so that the adapter base portion 126 of the adapter plate 108 may abut flush against the hanger base portion 110 of the hanger plate 106.

The hanger bar 132 extends between the first and second adapter side flanges 128, 130. The hanger bar 132 is configured to fit into the recessed seat sections 118 of the first and second hanger side flanges 112, 114 to enable the adapter plate 108 to pivot against the hanger plate 106.

The latching mechanism 134 is attached to the adapter plate 108 and is operable to removably latch the adapter plate 108 to the hanger plate 106, when the adapter plate 108 is pivoted (by the hanger bar pivoting within the recessed seated sections 118) against the hanger plate 106. When the latching mechanism 134 of the adapter plate 108 is latched to the hanger plate 106, the first and second adapter side flanges 128, 130 fit over the first and second hanger side flanges 112, 114 and the adapter base portion 126 abuts flush against the hanger base portion 110.

Additionally, when the latching mechanism 134 of the adapter plate 108 is latched to the hanger plate 106, the hanger top flange 120 extends at least partially over the hanger bar 132 to prevent the hanger bar 132 from moving vertically out of the recessed seat sections 116 of the first and second hanger side flanges 112, 114. Also, when the latching mechanism 134 of the adapter plate 108 is latched to the hanger plate 106, the raised upper corner portions 118 of the first and second hanger side flanges 112, 114 prevent the hanger bar 132 from moving horizontally out of the recessed seat sections 116. Accordingly, the adapter plate 108 and hanger plate 106 are latched securely together until the latching mechanism 134 is disengaged from the hanger plate 106.

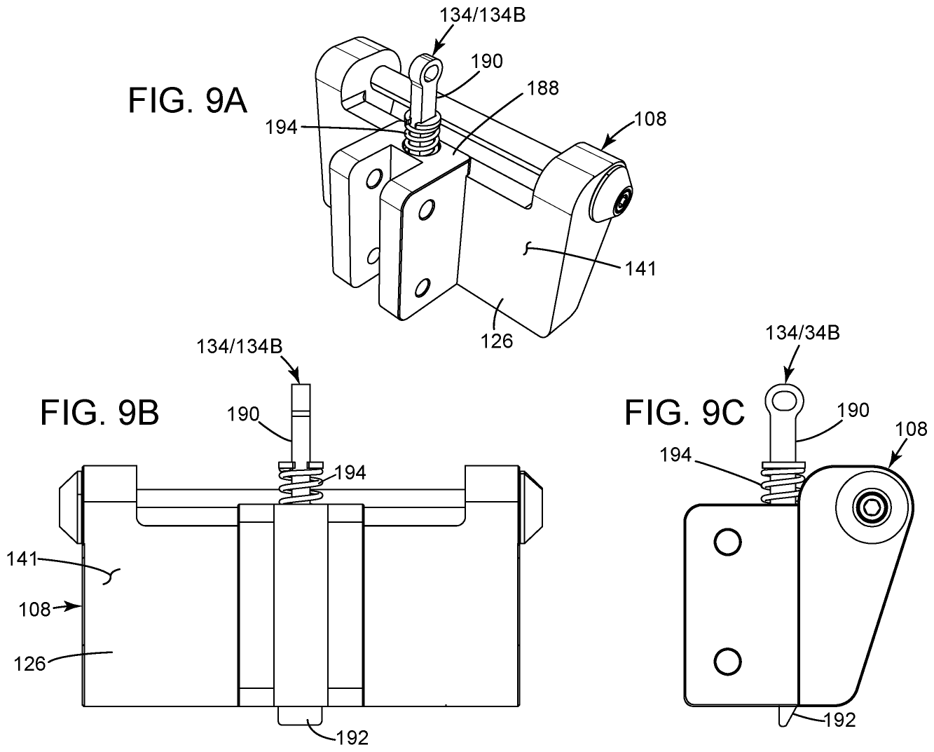

As illustrated in FIGS. 3A-3C, the latching mechanism 134 may include a spring loaded hook assembly 134A. However, the latching mechanism 134 may include any appropriate latching mechanism that meets the required performance parameters. For example, the latching mechanism 134 may include a spring loaded pin assembly 134B as illustrated in FIGS. 9A-9C.

Additionally, the adapter plate 108 may also include a first midsection flange 138 and a second midsection flange 140. The first and second midsection flanges 138, 140 extend forwardly from the front surface 141 of the adapter base portion 126 of the adapter plate 108. The midsection flanges 138, 140 are parallel to each other and straddle the latching mechanism 134. As will be explained in greater detail herein, the midsection flanges may be used to facilitate connections to various hitch receiver mounted accessory systems 200 (see FIGS. 10-13).

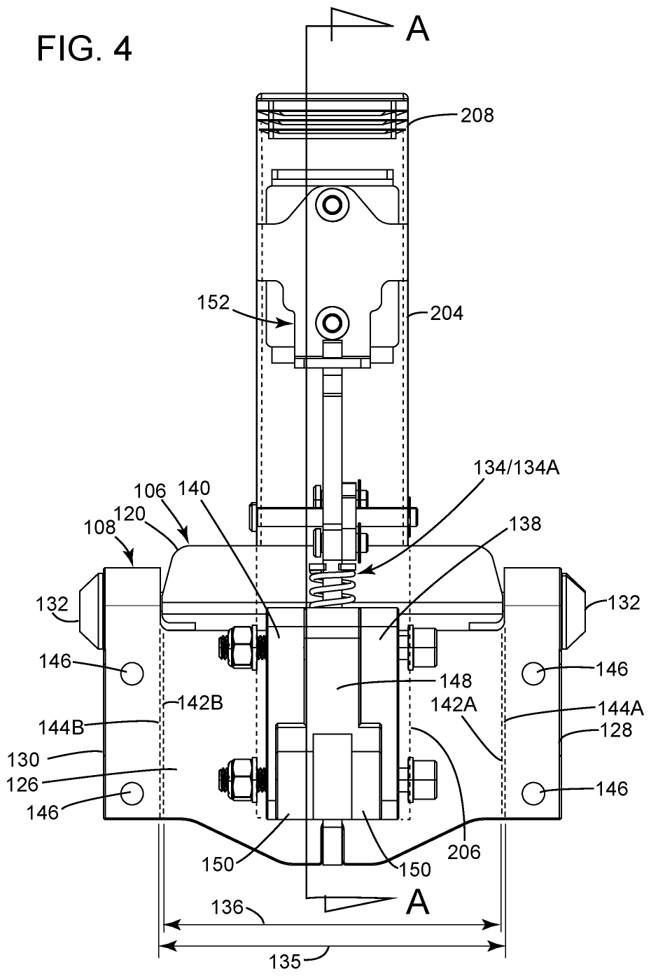

Referring to FIG. 4, an example is depicted of a front view of the quick disconnect system 100, wherein the hanger plate 106 and adapter plate 108 are fully engaged, according to aspects described herein. In this front view, because the adapter plate 108 is wider than the hanger plate 106, the adapter plate 108 covers most of the hanger plate 106, except for the hanger top flange 120, which extends upwardly and rearwardly over the hanger bar 132 of the adapter plate 108.

However, for purposes of clarity, the outer edges 142A, 142B of the hanger plate 106, which indicate the overall width 136, are shown in dotted lines. Additionally, the inside edge 144A of the first adapter side flange 128 and the inside edge 144B of the second adapter side flange 130 are shown in dotted lines. As can be seen, the first and second adapter side flanges 128, 130 of the adapter plate 108 are spaced apart a distance 135 that is greater than the overall width 136 of the hanger plate 106. Therefore, when the latching mechanism 134 of the adapter plate 108 is latched to the hanger plate 106, the first and second adapter side flanges 128, 130 fit over the hanger plate 106 (including the first and second hanger side flanges 112, 114) and the adapter base portion 126 abuts flush against the hanger base portion 110.

The first and second adapter side flanges 128, 130 and the first and second midsection flanges 138, 140 of the adapter plate 108 may also include a plurality of thru-holes 146 that can be used to mount various connections to portions of a hitch receiver mounted accessory system 200, such as a rake system (see FIGS. 10-13). By way of example, and as illustrated in FIG. 4, a two-pronged jack adapter 148 may be bolted between the first and second midsection flanges 138, 140 through thru-holes 146. As will be explained in greater detail herein, the two prongs 150 of the two-pronged jack adapter 148 may be used to straddle, and bolt to, a distal end portion 228 of an extendable member 226 of a jack assembly 224 of a hitch receiver mounted accessory system 200 (such as a rack system 200), thereby pivotally connecting the extendable member 226 to the adapter plate 108 (see FIG. 10).

Also, by way of example, and as illustrated in FIG. 4, a front post 204 (ghosted in to show release mechanism 152) of the rack system 200 may straddle the outside surfaces of the first and second midsection flanges 138, 140 and may also be bolted to the midsection flanges 138, 140 through thru-holes 146. Accordingly, the front post 204 will be rigidly connected to the adapter plate 108 at a lower end portion 206 of the front post 204 and extend upwards from the adapter plate 108 to an upper end portion 208 of the front post 204. The front post 204 may also include a spring hook release mechanism 152, which is designed to disengage the latching mechanism 134/spring loaded hook assembly 134A from the hanger plate 106.

Referring to FIG. 5, an example is depicted of a cross sectional view of the quick disconnect system 100 taken along the line A-A in FIG. 4, wherein the hanger plate 106 and adapter plate 108 are fully engaged, according to aspects described herein. Additionally, the latching mechanism 134 includes the spring loaded hook assembly 134A as illustrated in FIGS. 3A-C and 4.

The spring loaded hook assembly 134A includes a hook housing 154 rigidly attached to the front surface 141 (see FIG. 3A) of the adapter base portion 126. The hook assembly 134A also includes a hook 156. The hook 156 includes a vertical member 158 disposed within the hook housing 154, which is integrally attached to a horizontal member 160 extending rearwardly in the direction of the vehicle 104 under a bottom portion 162 of the adapter plate 108. The horizontal member 160 has a tapered distal end 164, which includes a raised latching portion 166. The raised latching portion 166 is designed to latch onto a rear surface of the hanger plate 106 to latch the adapter plate 108 to the hanger plate 106. The hook assembly 134A also includes a spring 168 disposed within the hook housing 154 and engaged with the vertical member 158 such that the spring 168 urges the hook 156 vertically upwards.

When the hanger bar 132 of the adapter plate 108 is fit into the recessed seat sections 116 of the hanger plate 106, and the adapter plate 108 is pivoted against the hanger plate 106, the tapered distal end 164 of the hook 156 engages a bottom of the hanger plate 106 to urge the hook 156 downward until the raised latching portion 166 clears the hanger plate bottom. Whereupon the spring 168 urges the hook 156 upward to engage and latch the hook 156 to the hanger plate 106. Once the hook 156 is latched to the hanger plate 106, the vertical member 158 is operable to be pushed downward via the spring hook release mechanism 152 to disengage the adapter plate 108 from the hanger plate 106.

The hanger plate 106 may be rigidly attached to a shank 169, such as by welding, bolting or the like. The shank 169 may be configured to fit into the thru-hole 124 of the receiver hitch 102. The shank 169 can be secured within the receive hitch 102 by any appropriate connection device that meets the required performance parameters. By way of example, the shank 169 may be secured within the thru-hole 124 of the receiver hitch 102 via bolt and cotter pin combination (not shown), by a threaded bolt 171, or other similar fastening system.

Alternatively, the hanger plate 106 may be directly rigidly attached to the hitch receiver 102 via welding, bolting or other similar fastening system. In that case, the base thru-hole 122 (see FIG. 2A) of the hanger plate 106 is configured to fit over the thru-hole 124 of the hitch receiver 102, when the hanger plate 106 is attached to the hitch receiver 102.

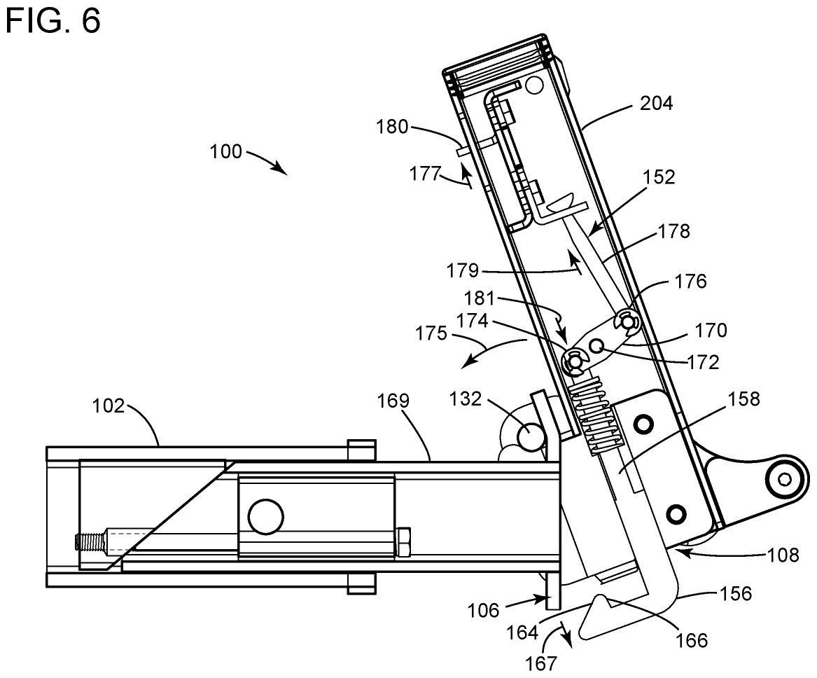

Referring to FIG. 6, an example is depicted of a cross sectional view of the quick disconnect system 100 taken along the line A-A in FIG. 4, wherein the hanger plate 106 and adapter plate 108 are partially disengaged, according to aspects described herein. As can be seen, the spring hook release mechanism 152 has been engaged to force the hook 156 downward (as indicated by directional arrow 167) a distance that disengages the raised latching portion 166 of the tapered distal end 164 of the hook 156. With the hook 154 disengaged from the hanger plate 106, the adapter plate 108 is able to pivot (as indicated by directional arrow 175) on its hanger bar 132 and swing the bottom portion of the adapter plate 108 away from the hanger plate 106.

More specifically, in this embodiment, the spring hook release mechanism 152 includes a lever 170 pivotally attached to a fulcrum 172. The fulcrum 172 is rigidly attached to the first post 204. A first end 174 of the lever 170 is pivotally attached to an upper portion of the vertical member 158 of the hook 156. A second end 176 of the lever 170 is pivotally attached to a linkage 178 that is connected to a handle 180. Accordingly, when the handle 180 is pulled upwards (as indicated by directional arrow 177), the linkage 178 pulls the second end 176 of the lever 170 upward (as indicated by directional arrow 179). The lever 170 then pivots on the fulcrum 172 to force the first end 174 downward (as indicated by directional arrow 181). Forcing the first end 174 of the lever 170 down also pushes the hook 156 down to disengage the hook 156 from the hanger plate 106, which allows the adapter plate 108 to swing away from the hanger plate 106.

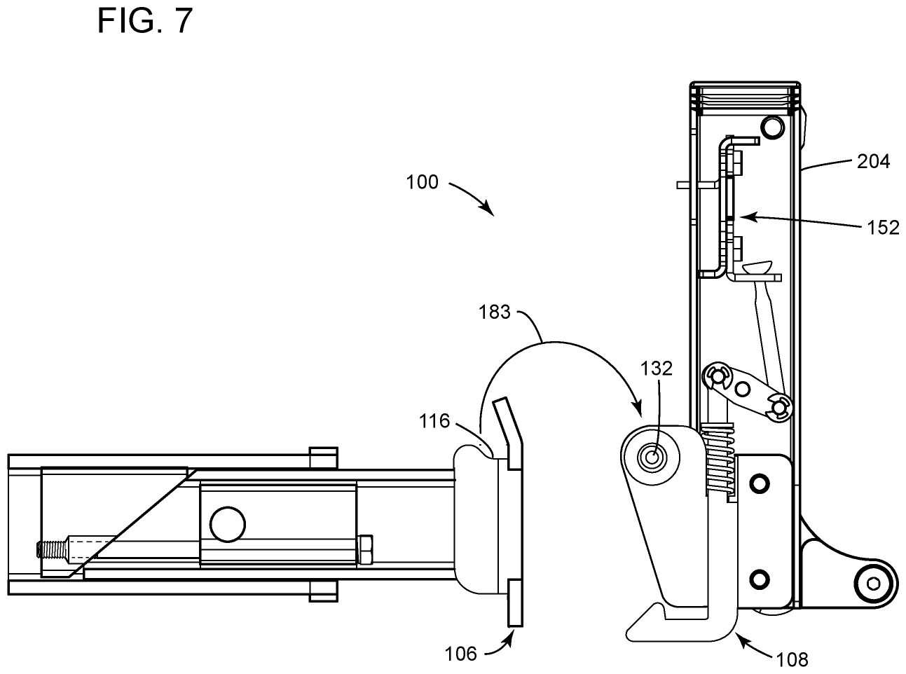

Referring to FIG. 7, an example is depicted of a cross sectional view of the quick disconnect system 100 taken along the line A-A in FIG. 4, wherein the hanger plate 106 and adapter plate 108 are fully disengaged, according to aspects described herein. As can be seen, once the adapter plate 108 is swung away from the hanger plate 106, the hanger bar 132 of the adapter plate 108 may be lifted (as indicated by directional arrow 183) off of the recessed seat sections 116 of the hanger plate 106 to completely disengage the adapter plate 108 from the hanger plate 106.

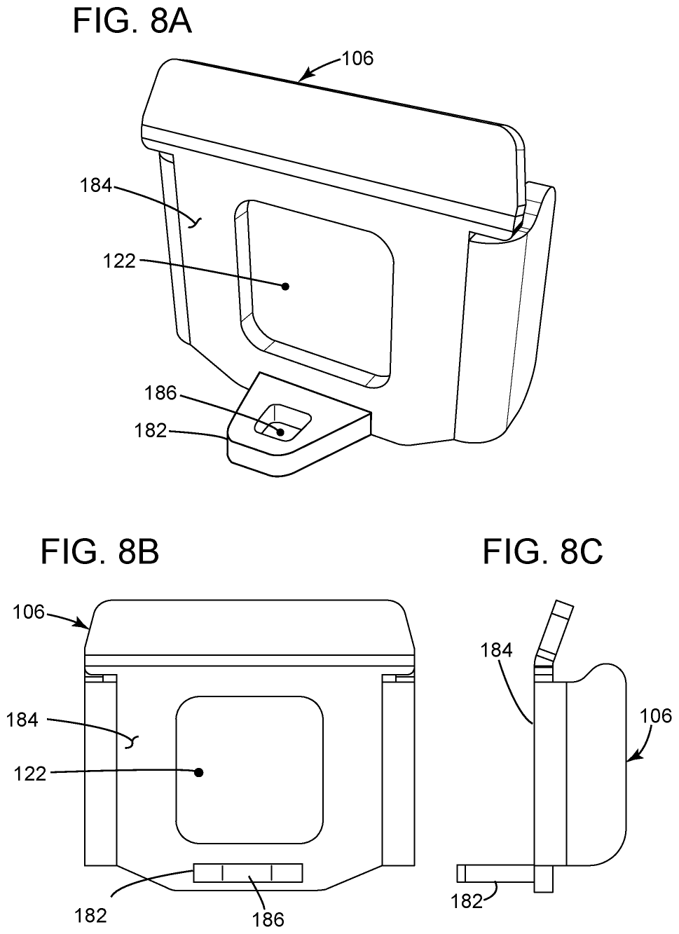

Referring to FIGS. 8A, 8B and 8C, an alternative example is depicted of a perspective view (FIG. 8A), a front view (FIG. 8B) and a side view (FIG. 8C) of the hanger plate 106 of the quick connect system 100 for a hitch receiver 102, according to aspects described herein. The hanger plate 106 in these FIGS. 8A-8C is similar to the hanger plate 106 in FIGS. 2A-2C except for the addition of a pin lock plate 182. The pin lock plate 182 is rigidly attached to, and projects outwardly from, a front surface 184 of the hanger plate 106. The pin lock plate 182 has a pin thru-hole 186 disposed therethrough.

Referring to FIGS. 9A, 9B and 9C, an alternative example is depicted of a perspective view (FIG. 9A), a front view (FIG. 9B) and a side view (FIG. 9C) of the adapter plate 108 of the quick connect system 100 for a hitch receiver 102, according to aspects described herein. The adapter plate 108 in these FIGS. 9A-9C is similar to the adapter plate 108 in FIGS. 3A-3C except that the latching mechanism 134 is a spring loaded pin assembly 134B rather than a spring loaded hook assembly 134A.

The spring loaded pin assembly 134B includes a pin housing 188 rigidly attached to the front surface 141 of the adapter base portion 126. A pin 190 is disposed within the pin housing 188. The pin has a tapered distal end 192 that is configured to fit into the pin thru-hole 186 of the pin lock plate 182 on the hanger plate 106. The pin assembly 134B also includes a spring 194 that is disposed within the pin housing 188. The spring 194 is engaged with the pin 190 such that the spring 194 urges the pin 190 vertically downwards.

When the hanger bar 106 of the adapter plate 108 is fit into the recessed seat sections 116 of the hanger plate, and the adapter plate 108 is pivoted against the hanger plate 106, the tapered distal end 192 of the pin 190 engages the pin lock plate 182 of the hanger plate 106. Upon engagement, the pin lock plate 182 urges the pin 190 upward until the pin 190 reaches the pin thru-hole 186, whereupon the spring 194 then urges the pin 190 downward into the pin thru-hole 186 of the pin lock plate 182 of the hanger plate 106. When, the pin 190 is latched into the pin thru-hole 186 of the hanger plate 106, the pin 190 is operable to be pushed upward via a release mechanism (not shown) to disengage the adapter plate 108 from the hanger plate 106.

Though the latching mechanism 134 may include a spring loaded hook assembly 134A or a spring loaded pin assembly 134B, the latching mechanism 134 may include any appropriate latching mechanism that meets the required performance parameters. For example, the latching mechanism 134 may not be spring loaded at all, but may be attached and disconnected manually without the use of a spring or may be attached and disconnected with a key mechanism. Also by way of example, the latching mechanism may include a loop assembly rather than a hook or pin assembly.

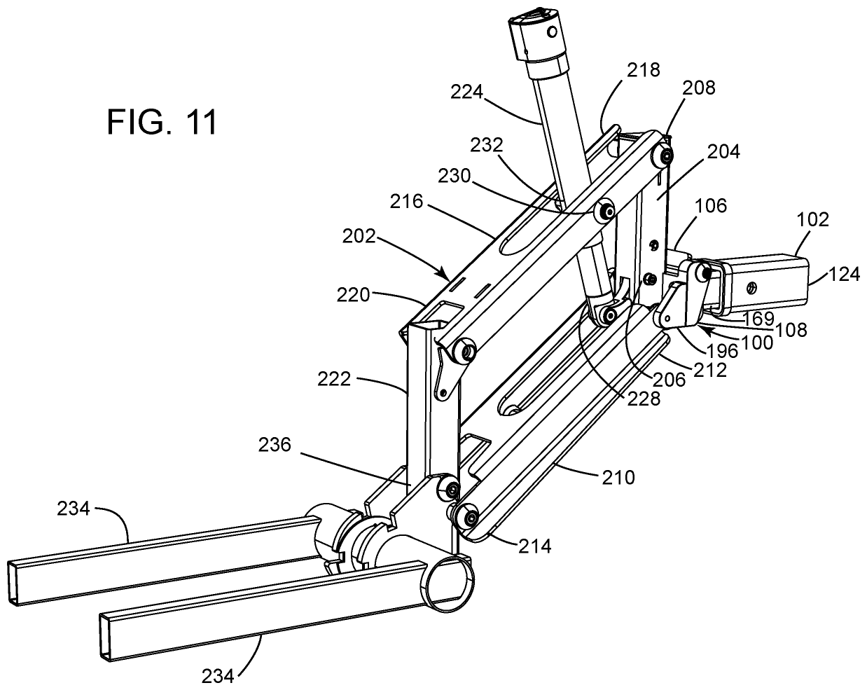

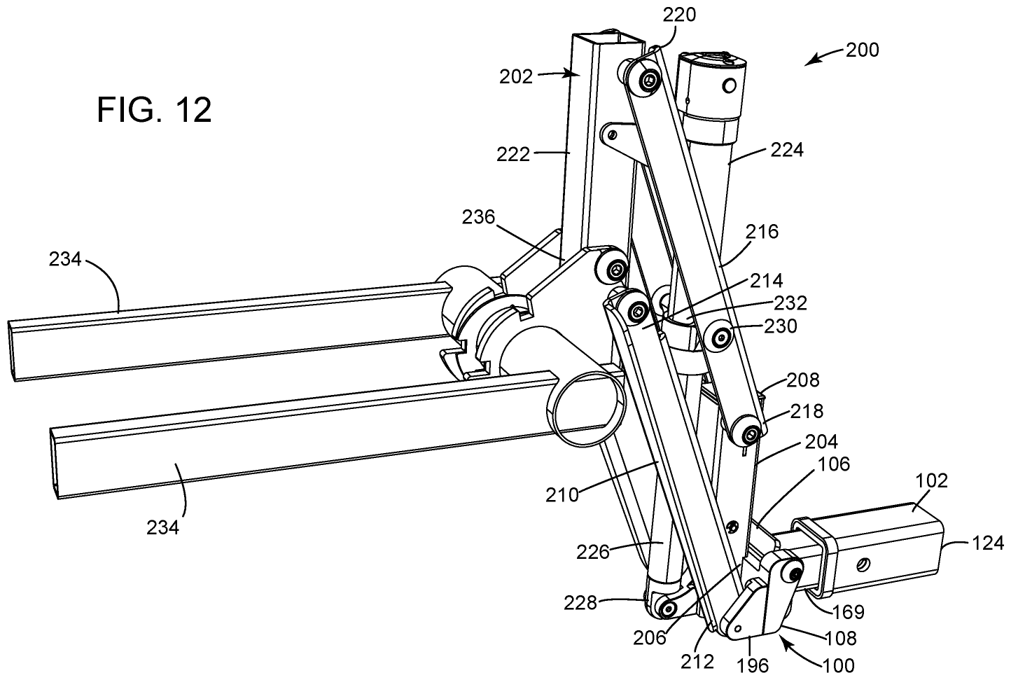

Referring to FIGS. 10, 11 and 12, an example is depicted of a perspective view of a hitch receiver mounted accessory system 200 in a loading position (FIG. 10), in a partially lifted position (FIG. 11) and in a fully lifted position (FIG. 12), according to aspects described herein. In the example illustrated in FIGS. 10-12, the hitch receiver mounted accessory system 200 includes a rack system 200 that is engageable to a hitch receiver 102. A rack system, as used herein, is an accessory that includes a frame or frame assembly that is used to hold objects. However, the hitch receiver mounted accessory system 200 may be other accessories as well. For example, the hitch receiver mounted accessory system 200 may be a simple platform accessory that is rigidly connected to the quick connect system 100.

The hitch receiver mounted accessory system/rack system 200 includes the quick connect system 100. The quick disconnect system 100 includes the hanger plate 106 configured to attach to the hitch receiver 102. In this case, the hanger plate 106 is mounted to a shank 169, which is configured to fit into the thru-hole 124 of the hitch receiver 102. However, the hanger plate 106 could also be mounted directly to the hitch receiver 102. The quick connect system 100 also includes the adapter plate 108, which is configured to removably attach to the hanger plate 106.

The rack system 200 also includes a frame assembly 202. The frame assembly includes a first post 204 rigidly connected to the adapter plate 108 at a lower end portion 206 and extending upwards to an upper end portion 208. More specifically, the lower end portion 206 of first post 204 straddles the first and second midsection flanges 138, 140 of the adapter plate 108 and is bolted to them.

The frame assembly 202 of rack system 200 also includes a bottom lifter plate 210 that is pivotally connected to the adapter plate 108 at a first end portion 212 and extends outwards to a second end portion 214. More specifically, the first end portion 212 of the bottom lifter plate 210 are pivotally connected to the pair of lifter plate adapters 196 (see FIG. 1). The pair of lifter plate adapters 196 are bolted to the front surface 141 of the adapter plate 108 (see FIG. 1).

The frame assembly 202 also includes a top lifter plate 216, which is pivotally connected to the upper end portion 208 of the first post 204 at a first end portion 218 of the top lifter plate 216. The top lifter plate 216 extends outwards from the first end portion 218 to a second end portion 220 of the top lifter plate 216.

The frame assembly 202 also includes a second post 220, which is pivotally connected between the second end portion 220 of the top lifter plate 216 and the second end portion 214 of the bottom lifter plate 210 respectively. The second post 220 remains oriented substantially vertically as the frame assembly 202 pivots from a loading position (see FIG. 10) to a fully lifted position (see FIG. 12).

The rack system 200 also includes a jack assembly 224. The jack system has an extendable member 226, that is operable to extend and retract between a fully retracted position of the extendable member 226 (as illustrated in FIG. 10) and a fully extended position of the extendable member 226 (as illustrated in FIG. 12). The jack assembly 224 is pivotally connected to the adapter plate 108 at a distal end portion 228 of the extendable member 226 and pivotally connected to a midportion 230 of the top lifter plate 216 at a midportion 232 of the jack assembly 224. More specifically, the distal end portion 228 of the extendable member 226 may be inserted between, and pivotally connected to, the two prongs 150 of the two-pronged jack adapter 148. The two-pronged jack adapter may be fit between, and rigidly bolted to, the first and second midsection flanges 138, 140 of the adapter plate 108 (see FIG. 1).

The frame assembly 202 also includes a pair of lifter forks 234 attached to a lower end portion 236 of the second post 222. The pair of lifter forks 234 extend horizontally outwardly from the second post 222.

During operation, when the jack assembly 224 extends the extendable member 226 from the fully retracted position (see FIG. 10) to the fully extended position (see FIG. 12), the frame assembly 202 pivots around the first post 204 from a loading position (see FIG. 10) to a fully lifted position (see FIG. 12). In the loading position, the pair of lifter forks 234 are at ground level for ease of loading various items, such as bicycles, motor cycles, E-bikes, cargo or the like. Once the items have been loaded, the jack assembly 224 may be advantageously operated to extend the extendable member 226, which causes the frame assembly 202 to pivot from the loading position (see FIG. 10), through the partially lifted position (see FIG. 11) and up to the fully lifted position (see FIG. 12), with very little or no manual labor.

The jack assembly 224 may be any number of types of jack assemblies that meet the required performance parameters. For example, the jack assembly 224 may be screw jack assembly, a scissor jack assembly, an incompressible liquid hydraulic jack assembly, an air hydraulic jack assembly or the like.

As illustrated in FIGS. 10-12, the jack assembly 224 includes a screw jack assembly wherein the extendable member 226 includes a lead screw. The screw jack assembly uses the mechanical advantage of the threads of the lead screw to turn the rotational motion of the threads into linear motion of the lead screw. The screw jack assembly can be manually or electrically operated. For example, the lead screw may be turned by hand, using a wrench or other type of tool, or may be turned electrically with a cordless drill or an electric motor.

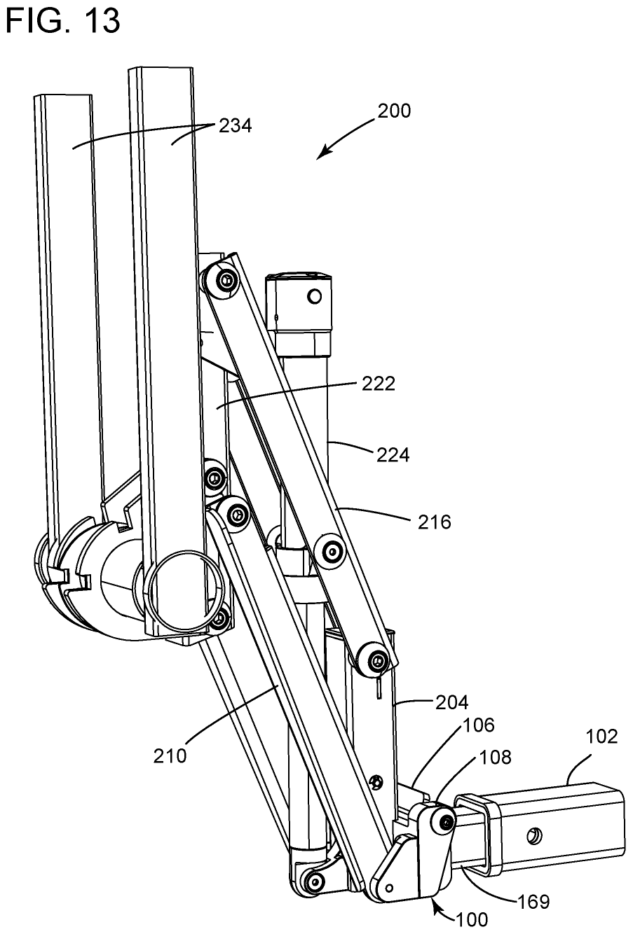

Referring to FIG. 13, an example is depicted of a perspective view of the hitch receiver mounted accessory system/jack system 200, in a fully lifted position and with the lifter forks 234 in a vertically extending storage position, according to aspects described herein. When not being used, the pair of lifter forks 234 are configured to pivot from a loading position (see FIGS. 10-12) to a storage position (see FIG. 13). When the lifter forks 234 are in the loading position, the lifter forks 234 extend horizontally at substantially a right angle relative to the second post 222 (see FIGS. 10-12). When the lifter forks 234 are in the storage position, the lifter forks 234 extend in a vertical direction relative to the second post 222 (see FIG. 13).

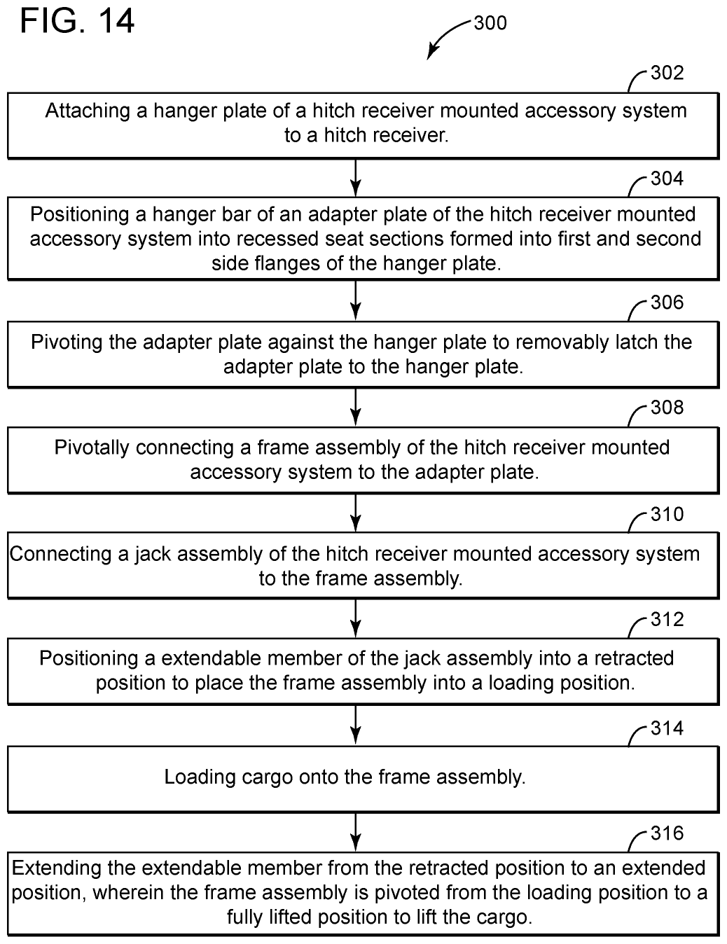

Referring to FIG. 14, an example is depicted of a flow diagram 300 of a method of lifting cargo with a hitch mounted accessory system 200 for a hitch receiver 102 of a vehicle 104, according to aspects described herein.

The method begins at 302, wherein a hanger plate 106 of a hitch receiver mounted accessory system 200 is attached to the hitch receiver 102 of a vehicle 104. The hitch receiver mounted accessory system 200 may be a rack system 200 (see FIGS. 10-13). The hanger plate 106 may be mounted directly to the hitch receiver 102. Alternatively, the hanger plate 106 may be mounted onto a shank 169, which is configured to fit into the thru-hole 124 of a hitch receiver 102 (see FIG. 1).

At 304, a hanger bar 132 of an adapter plate 108 of the hitch receiver mounted accessory system 200 is positioned into recessed seat sections 116 formed into a first hanger side flange 112 and a second hanger side flange 114 of the hanger plate 106 (see FIG. 5).

At 306, the adapter plate 108 is pivoted against the hanger plate 106 to removably latch the adapter plate 108 to the hanger plate 106. When the adapter plate 108 is latched to the hanger plate 106, raised upper corner portions 118 of the hanger side flanges 112, 114 prevent the hanger bar 132 from moving horizontally out of the recessed seat sections 116 and a hanger top flange 120 prevents the hanger bar 132 from moving vertically out of the recessed seat sections 116.

At 308, a frame assembly 202 of the hitch receiver mounted accessory system 200 is pivotally connected to the adapter plate 108. More specifically, a front post 204 of the frame assembly 202 is rigidly connected to the adapter plate 108 such that the front post 204 extends upwards from the adapter plate 108. A bottom lifter plate 210, a top lifter plate 216 are pivotally connected to the lower 206 and upper 208 end portions of the first post, such that the entire frame assembly (other than the front post 204) swings/pivots around the adapter plate 108.

At 310, a jack assembly 224 having an extendable member 226, of the hitch receiver mounted accessory system 200, is connected to the frame assembly 202. More specifically, the jack assembly 224 is pivotally connected to the adapter plate 108 at a distal end portion 228 of the extendable member 226 and pivotally connected to a midportion 230 of the top lifter plate 216 at a midportion 232 of the jack assembly 224 (see FIG. 11). The jack assembly 224 may be a screw jack assembly and the extendable member 226 may be a lead screw of the screw jack assembly.

At 312, the extendable member 226 of the jack assembly 224 is positioned into a retracted position to place the frame assembly 202 into a loading position (see FIG. 10). In the loading position, the pair of lifter forks 234 are at ground level for ease of loading various items, such as bicycles, motor cycles, E-bikes, cargo or the like.

At 314, cargo is loaded onto the frame assembly 202. The cargo may be loaded onto holding racks (not shown), which are then placed onto the lifter forks 234.

At 316, the extendable member 226 is extended from the retracted position to an extended position, wherein the frame assembly 202 is pivoted from the loading position to a fully lifted position to lift the cargo (see FIG. 12). The jack assembly 224 may be a screw jack assembly and the extendable member 226 may be the lead screw of the screw jack assembly. The screw jack assembly 224 may be operated manually or electrically to turn the lead screw and extend the lead screw from the retracted position to the extended positions and vice versa.

It should be appreciated that all combinations of the foregoing concepts and additional concepts discussed in greater detail herein (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

Although the invention has been described by reference to specific examples, it should be understood that numerous changes may be made within the spirit and scope of the inventive concepts described. Accordingly, it is intended that the disclosure not be limited to the described examples, but that it have the full scope defined by the language of the following claims.

What is claimed is:

1. A quick connect system for a hitch receiver of a vehicle, the quick connect system comprising:
a hanger plate comprising:
a hanger base portion configured to attach to the hitch receiver, and
first and second hanger side flanges extending rearwardly from opposing sides of the hanger base portion, wherein top surfaces of the hanger side flanges are each contoured to form a recessed seat section; and
an adapter plate comprising:
an adapter base portion,
first and second adapter side flanges extending rearwardly from opposing sides of the adapter base portion,
a hanger bar extending between the adapter side flanges, and
a latching mechanism attached to the adapter plate;
wherein, the hanger bar is configured to fit into the recessed seat sections to enable the adapter plate to pivot against the hanger plate and to removably latch the latching mechanism to the hanger plate.

2. The quick connect system of claim 1, comprising:
the hanger base portion having a base thru-hole extending therethrough, the base thru-hole configured to fit over a thru-hole of the hitch receiver, when the hanger plate is attached to the hitch receiver.

3. The quick connect system of claim 1, comprising:
a hanger top flange extending rearwardly at an acute angle from a top of the hanger base portion, the hanger top flange extending over the recessed seat sections of the first and second hanger side flanges;
wherein, when the latching mechanism of the adapter plate is latched to the hanger plate, the hanger top flange prevents the hanger bar from moving vertically out of the recessed seat sections.

4. The quick connect system of claim 1, comprising:
the first and second hanger side flanges each including a raised upper corner portion, which forms a portion of the recessed seat sections;
wherein, when the latching mechanism of the adapter plate is latched to the hanger plate, the raised upper corner portions of the first and second hanger side flanges prevent the hanger bar from moving horizontally out of the recessed seat sections.

5. The quick connect system of claim 1, comprising:
the first and second adapter side flanges of the adapter plate being spaced apart a distance greater than an overall width of the hanger plate;
wherein, when the latching mechanism of the adapter plate is latched to the hanger plate, the first and second adapter side flanges fit over the first and second hanger side flanges and the adapter base portion abuts flush against the hanger base portion.

6. The quick disconnect system of claim 1, wherein the latching mechanism comprises a spring loaded hook assembly.

7. The quick connect system of claim 6, wherein the spring loaded hook assembly comprising:
a hook housing rigidly attached to a front surface of the adapter base portion;
a hook comprising:
a vertical member disposed within the hook housing, and
a horizontal member extending rearwardly under a bottom portion of the adapter plate, the horizontal member having a tapered distal end, the tapered distal end including a raised latching portion; and
a spring disposed within the hook housing and engaged with the vertical member such that the spring urges the hook vertically upwards.

8. The quick disconnect system of claim 7, wherein:
when the hanger bar is fit into the recessed seat sections and the adapter plate is pivoted against the hanger plate, the tapered distal end of the hook engages a bottom of the hanger plate to urge the hook downward until the raised latching portion clears the hanger plate bottom, whereupon the spring urges the hook upward to engage and latch the hook to the hanger plate; and
when, the hook is latched to the hanger plate, the vertical member is operable to be pushed downward to disengage the adapter plate from the hanger plate.

9. The quick connect system of claim 1, wherein the latching mechanism comprises a spring loaded pin assembly.

10. The quick connect system of claim 9, wherein the spring loaded pin assembly comprises:
a pin housing rigidly attached to a front surface of the adapter base portion;
a pin disposed within the pin housing, the pin having a tapered distal end;
a spring disposed within the pin housing and engaged with the pin such that the spring urges the pin vertically downwards; and
a pin lock plate rigidly attached to, and projecting outwardly from, a front surface of the hanger plate, the pin lock plate having a pin thru-hole disposed therethrough, the pin thru-hole configured to receive the tapered distal end of the pin;
wherein when the hanger bar is fit into the recessed seat sections and the adapter plate is pivoted against the hanger plate, the tapered distal end of the pin engages the pin lock plate of the hanger plate to urge the pin upward until the pin reaches the pin thru-hole, whereupon the spring urges the pin downward into the pin thru-hole of the hanger plate; and
when, the pin is latched into the pin thru-hole of the hanger plate, the pin is operable to be pushed upward to disengage the adapter plate from the hanger plate.

11. A hitch receiver mounted accessory system for a hitch receiver of a vehicle, the hitch receiver mounted accessory system comprising:
a quick connect system comprising:
a hanger plate configured to attach to the hitch receiver, and
an adapter plate configured to removably attach to the hanger plate:
a frame assembly comprising:
a first post rigidly connected to the adapter plate at a lower end portion and extending upwards to an upper end portion,
a bottom lifter plate pivotally connected to the adapter plate at a first end portion and extending outwards to a second end portion,
a top lifter plate pivotally connected to the upper end portion of the first post at a first end portion and extending outwards to a second end portion, and
a second post pivotally connected between the second end portions of the top and bottom lifter plates; and
a jack assembly having an extendable member, the extendable member operable to extend and retract between a fully retracted position and a fully extended position, the jack assembly pivotally connected to the adapter plate at a distal end portion of the extendable member and pivotally connected to a midportion of the top lifter plate at a midportion of the jack assembly;
wherein, when the jack assembly extends the extendable member from the fully retracted position to the fully extended position, the frame assembly pivots around the first post from a loading position to a fully lifted position.

12. The hitch receiver mounted accessory system of claim 11, wherein the quick connect system comprises:
the hanger plate comprising:
a hanger base portion configured to attach to the hitch receiver, and
first and second hanger side flanges extending rearwardly from opposing sides of the hanger base portion, wherein top surfaces of the hanger side flanges are each contoured to form a recessed seat section;
the adapter plate comprising:
an adapter base portion,
first and second adapter side flanges extending rearwardly from opposing sides of the adapter base portion, and
a hanger bar extending between the adapter side flanges;
wherein, the hanger bar is configured to fit into the recessed seat sections to enable the adapter plate to pivot against the hanger plate.

13. The hitch receiver mounted accessory system of claim 12, wherein the quick connect system comprises:
a latching mechanism attached to the adapter base portion;
wherein, when the hanger bar is fit into the recessed seat sections and the adapter plate is pivoted against the hanger plate, the latching mechanism is removably latched to the hanger plate.

14. The hitch receiver mounted accessory system of claim 12, comprising:
the hanger base portion having a base thru-hole extending therethrough, the base thru-hole configured to fit over a thru-hole of the hitch receiver, when the hanger plate is attached to the hitch receiver.

15. The hitch receiver mounted system of claim 11, wherein the jack assembly comprises a screw jack assembly and the extendable member comprises a lead screw.

16. The hitch receiver mounted accessory system of claim 11, wherein the frame assembly comprises:
a pair of lifter forks attached to a lower end portion of the second post, the pair of lifter forks extending horizontally outwardly from the second post.

17. The hitch receiver mounted accessory system of claim 16, comprising:
the pair of lifter forks configured to pivot from a loading position to a storage position;
wherein, when in the loading position, the lifter forks extend horizontally at substantially a right angle relative to the second post; and
wherein, when in the storage position, the lifter forks extend in a vertical direction relative to the second post.

18. The hitch receiver mounted accessory system of claim 11, wherein the hitch receiver mounted accessory system comprises a rack system engageable to a hitch receiver of a vehicle.

19. A method of lifting cargo with a hitch receiver mounted accessory system for a hitch receiver of a vehicle, the method comprising:
attaching a hanger plate of the hitch receiver mounted accessory system to the hitch receiver;
positioning a hanger bar of an adapter plate of the hitch receiver mounted accessory system into recessed seat sections formed into first and second hanger side flanges of the hanger plate; and
pivoting the adapter plate against the hanger plate to removably latch the adapter plate to the hanger plate.

20. The method of claim 19, comprising:
pivotally connecting a frame assembly of the hitch receiver mounted accessory system to the adapter plate;
connecting a jack assembly of the hitch receiver mounted accessory system to the frame assembly;
positioning an extendable member of the jack assembly into a retracted position to place the frame assembly into a loading position;
loading cargo onto the frame assembly; and
extending the extendable member from the retracted position to an extended position, wherein the frame assembly is pivoted from the loading position to a fully lifted position to lift the cargo.
